(19) United States
(12) Patent Application Publication
(10) Pub. No.: US 2022/0281167 A1
(43) Pub. Date: Sep. 8, 2022

(54) 3D PRINTER HAVING MICROHOLE PROCESSING FUNCTION, AND METHOD FOR PROCESSING MICROHOLE BY USING SAME

(71) Applicant: KOREA ADVANCED INSTITUTE OF SCIENCE AND TECHNOLOGY, Daejeon (KR)

(72) Inventors: JUNG-WUK HONG, Daejeon (KR); Kwonhwan KO, Daejeon (KR); Sangmin LEE, Daejeon (KR)

(73) Assignee: KOREA ADVANCED INSTITUTE OF SCIENCE AND TECHNOLOGY, Daejeon (KR)

(21) Appl. No.: 17/632,210

(22) PCT Filed: Jul. 9, 2020
(86) PCT No.: PCT/KR2020/008985

§ 371 Date: Feb. 1, 2022

(30) Foreign Application Priority Data
Aug. 2, 2019 (KR) 10-2019-0094152

(51) Int. Cl. B29C 64/188; B33Y 10/00; B33Y 30/00; B29C 64/135; B29C 64/268; B29C 64/277; B29C 64/214

(52) U.S. Cl. CPC B29C 64/188; B33Y 10/00; B33Y 30/00; B29C 64/135; B29C 64/268; B29C 64/277; B29C 64/214

(57) ABSTRACT

A 3D printer with fine hole processing function in accordance with an embodiment of the present invention, comprises: a build plate, a first laser unit, and a second laser unit. The build plate is disposed in a photocurable liquid resin contained in a water tank. The first laser unit is disposed on the water tank and the photocurable liquid resin, and irradiates a first beam to the photocurable liquid resin on the build plate to cure and laminate the photocurable liquid resin one layer by one layer on the build plate thereby forming a structure. The second laser unit is disposed to be spaced apart from the first laser unit by a predetermined distance, and irradiates a second beam to the structure where the photocurable liquid resin is cured and deposited on the build plate thereby forming a fine hole. The first beam is an ultraviolet laser beam for curing, and the second beam is an ultraviolet solid laser beam having a laser drilling function.

A method of processing fine holes with a 3D printer having a fine hole processing function, where a position of a fine hole on a xy plane of a structure 300 to be output is set to be constantly processed up to a first point in a z-axis direction, comprises: a first step, when a modeling file of the structure to be output is input to the 3D printer, where the first laser unit irradiates the first beam to the build plate, and accordingly, the photocurable liquid resin contained in the water tank is cured and deposited one layer by one layer to output a first structure up to the first point in the z-axis direction, and a second step where a second laser unit irradiates a second beam to the first structure which is output up to the first point in the z-axis direction to form a first fine hole in the first structure.

### TECHNICAL FIELD

The present invention relates to a 3D printer, more specifically, to an SLA method-based 3D printer having a fine hole processing function and a method of processing fine holes using the same.

### BACKGROUND ART

3D printing technology is a technology capable of elaborately manufacturing complex and diverse types of structures without additional manpower or manufacturing technology. So far, several types of 3D printing technologies have been developed, among which the most commonly used methods are fused deposition modeling (FDM) and stereolithography apparatus (SLA).

The FDM type 3D printer is a printer that generates a structure by melting the material and stacking it one layer at a time. The SLA type 3D printer is a photocurable layered printer. The SLA-type 3D printer makes a structure by using a photocurable liquid photopolymer which hardens when subjected to ultraviolet rays. Among them, the FDM type 3D printers are most widely used, but there is a disadvantage in that the finished structure is less sophisticated compared to SLA type 3D printers. Therefore, when the FDM type 3D printer is applied to industrial fields requiring structural precision such as electronic packaging manufacturing, it may be said that the SLA type 3D printer as shown in FIG. 1 is more suitable.

In addition to 3D printing technology, laser micropore processing technology is a key technology used in all high-tech industries which require mass production and accurate assembly, including electronic devices including semiconductors, aviation, medical, bio and robot industries.

The micropore processing technique using a laser can generally be used for all kinds of metal and non-metal materials. In addition, the size, number, and depth of the holes may be adjusted using 3D data. Therefore, fast and accurate processing on the surface of the material is possible without replacing the tool (a tool used for general hole processing) according to the conditions of the hole.

However, conventional micropore processing equipment may not meet the efficiency required in advanced electronic industries such as semiconductors and displays. With the prior art, fine holes can be additionally processed only for structures already manufactured. In addition, it is understood that in the prior art, the processing process cannot be performed together during the manufacturing process of a specific structure. This means that in order to manufacture a complex structure where fine holes are generated, two main tasks, that is, structure manufacturing and fine hole processing, must be performed independently. This means that manpower and processing techniques must be additionally introduced. In addition, even when the fine hole conditions (shape, diameter, density) are different for each part of the specific structure, additional tasks such as changing the position of the specimen and changing the fine hole processing conditions should be performed during the processing processes.

Therefore, there is a need for a technology capable of elaborately manufacturing various types of structures without additional manpower or processing technology. In addition, there is a need for a technique capable of processing micropores of various conditions for a structure. In addition, there is a need for a technique capable of flexibly alternately performing the structure manufacturing process and the fine hole processing process. Accordingly, it is possible to generate fine holes differently for each part of a specific structure, or to generate fine holes only partially.

### RELATED ART DOCUMENT

### (Patent Document 1) Korean Laid-Open Patent Publication No. 10-2014-0116747 (Published Date: Oct. 6, 2014)

### DISCLOSURE

### Technical Problem

An object of the present invention is to provide a 3D printer capable of processing a large number of fine holes capable of performing heat dissipation, air circulation, and waterproof functions, and a method of processing fine holes using the same.

The purpose of the present invention is to provide a 3D printer capable of manufacturing fine holes in a specific structure without limitation in the shape and standard of the fine holes and without limitation in the diameter and numbers of the fine holes and manufacturing the fine holes in the structure using the same.

However, an object of this invention is not limited to the above objects, and may be variously extended within the spirit and area of this invention.

### Technical Solution

In order to achieve the object of the present invention, a 3D printer with fine hole processing function in accordance with an embodiment of the present invention, comprises: a build plate, a first laser unit, and a second laser unit. The build plate is disposed in a photocurable liquid resin contained in a water tank. The first laser unit is disposed on the water tank and the photocurable liquid resin, and irradiates a first beam to the photocurable liquid resin on the build plate to cure and laminate the photocurable liquid resin one layer by one layer on the build plate thereby forming a structure. The second laser unit is disposed to be spaced apart from the first laser unit by a predetermined distance, and irradiates a second beam to the structure where the photocurable liquid resin is cured and deposited on the build plate thereby forming a fine hole. The first beam is an ultraviolet laser beam for curing, and the second beam is an ultraviolet solid laser beam having a laser drilling function.

According to an embodiment, the first beam generated by the first laser unit is irradiated to the photocurable liquid resin through a first scanner. The second beam generated by the second laser unit is irradiated to the structure where the photocurable liquid resin is cured and deposited, through a second scanner.

According to an embodiment, the 3D printer with fine hole processing function of claim 1, further comprises: a recoater blade for refining the surface of the one layer of the resin layer where the photocurable liquid resin is cured and deposited one layer by one layer.

According to one embodiment, after the recoater blade refines the surface of the one layer of the resin layer, a structure is formed by repeating the process of: moving the build plate by a thickness of one layer in a vertical direction, further depositing a new layer of resin layer, and refining by the recoater blade the surface of the one layer of the resin layer which is newly deposited.

In order to achieve another object of the present invention, a method of processing fine holes with a 3D printer having a fine hole processing function, where a position of a fine hole on a xy plane of a structure 300 to be output is set to be constantly processed up to a first point in a z-axis direction, comprises: a first step, when a modeling file of the structure to be output is input to the 3D printer, where the first laser unit irradiates the first beam to the build plate, and accordingly, the photocurable liquid resin contained in the water tank is cured and deposited one layer by one layer to output a first structure up to the first point in the z-axis direction, and a second step where a second laser unit irradiates a second beam to the first structure which is output up to the first point in the z-axis direction to form a first fine hole in the first structure.

According to an embodiment, the method of processing fine holes with a 3D printer having a fine hole processing function, when a position of a fine hole on the xy plane of the structure to be output is changed from the first point to a second point in the z-axis direction, further comprises: a third step where the first laser unit irradiates the first beam to the photocurable liquid resin on the first structure, and accordingly, the photocurable liquid resin contained in the water tank is cured and deposited one layer by one layer to output a second structure up to the second point in the z-axis direction, and a fourth step where the second laser unit further irradiates a second beam to the second structure which is output up to the second point in the z-axis direction to form a second fine hole in the second structure.

### Advantageous Effects

According to an embodiment of the present invention, a 3D printer having a fine hole processing function and a method of processing the fine holes using the same may process a large number of fine holes having well heat dissipation, air circulation, and waterproof functions.

In addition, micropores can be manufactured in specific structures without restrictions on the shape and specification of micropores, and micropores can be manufactured without restrictions on the diameter and number of micropores.

However, the effects of this invention are not limited to the effects, and may be variously extended within the spirit and region of this invention.

### DESCRIPTION OF DRAWINGS

FIG. 1 is a diagram illustrating a conventional SLA type 3D printer.

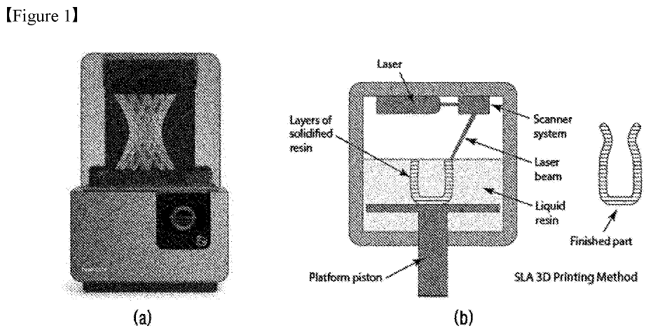

FIG. 2 is a diagram illustrating a 3D printer having a fine hole processing function according to an embodiment of the present invention.

FIG. 3 is a diagram schematically illustrating a position of a recoater blade in a 3D printer.

### MODE FOR INVENTION

Hereinafter, an embodiment of the present invention will be described in more detail with reference to the accompanying drawings. Among the configurations of the present invention, a detailed description of what may be clearly understood and easily reproduced by those skilled in the art will be omitted in order not to obscure the gist of the present invention.

Hereinafter, a 3D printer having a fine hole processing function according to an embodiment of the present invention and a method of processing fine holes using the same will be described.

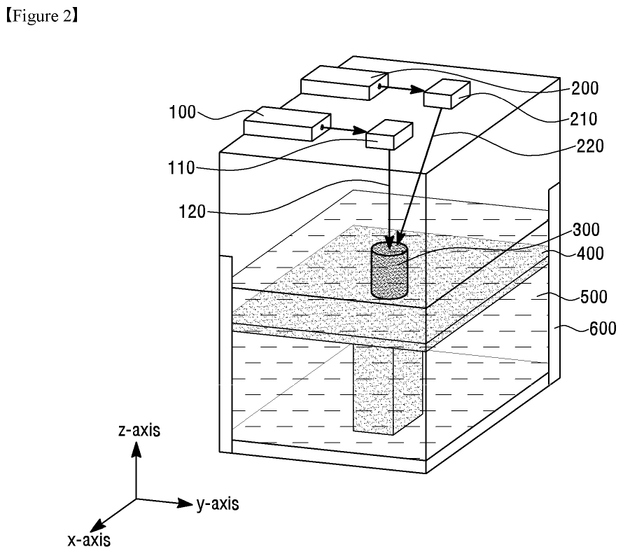

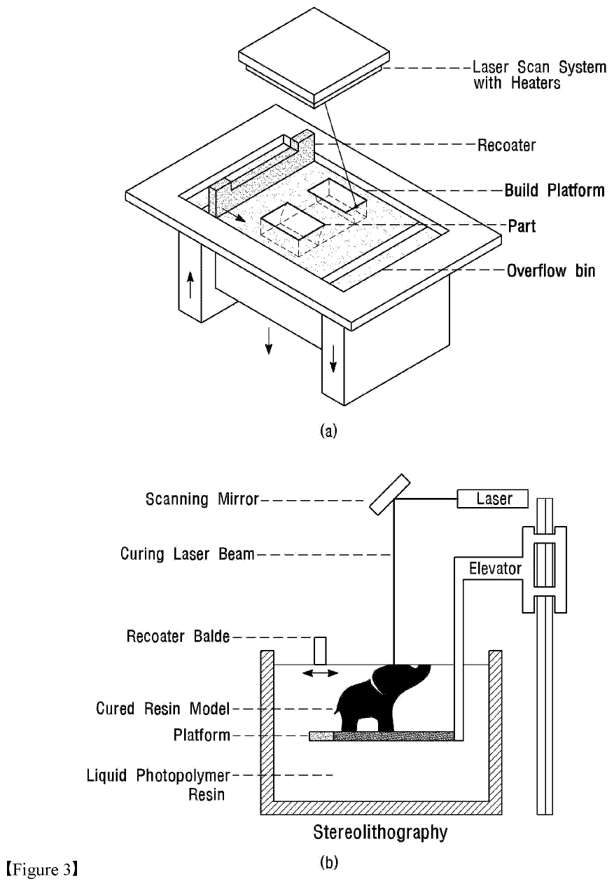

FIG. 2 is a diagram illustrating a 3D printer having a fine hole processing function according to an embodiment of the present invention. FIG. 3 is a diagram schematically illustrating a position of a recoater blade in a 3D printer.

Referring to FIGS. 2 and 3, a 3D printer having a fine hole processing function according to an embodiment of the present invention includes a first laser unit 100, a first scanner 110, a first beam 120, a second laser unit 200, a second scanner 210, a photocurable resin 500, and a build plate 400.

A 3D printer with a fine hole processing function in accordance with an embodiment of this invention is based on a stereolithography apparatus (SLA) method.

The SLA type 3D printer uses a method of solidifying a material using a polymerization reaction occurring in photocurable plastic by irradiation of light. Hereinafter, a 3D printer having a fine hole processing function according to an embodiment of the present invention will be described in detail.

The 3D printer having a fine hole processing function according to an embodiment of the present invention includes a build plate 400 disposed in the photocurable liquid resin 500 contained in a water tank 600.

In addition, it includes a first laser unit 100 disposed on the water tank 600 and the photocurable liquid resin 500, for irradiating a first beam 120 to the photocurable liquid resin 500 on the build plate 400 to cure and laminate the photocurable liquid resin 500 one layer by one layer on the build plate 400 thereby forming a structure 300.

The first beam 120 generated by the first laser unit 100 is an ultraviolet rays (UV) laser beam for curing. The first beam 120 is irradiated to the photocurable liquid resin 500 contained in the water tank 600 through the first scanner 110.

Here, the first scanner 110 may allow the laser transmitted from the first laser unit 100 to accurately reach a designated coordinate of the build plate 400. The first scanner 110 may include a galvanometer and an x-y scanning mirror.

More specifically, the first beam 120 is irradiated to the photocurable liquid resin 500 contained in the water tank 500 to cure and laminate (additive) the photocurable liquid resin 500 one layer by one layer thereby forming a structure 300.

On the build plate 400 to which the first beam 120 is irradiated, one layer of photocurable liquid resin 500 is cured, and a surface of the cured one layer of resin layer is refined by a recoater blade. In addition, the build plate 400 moves by a thickness of one layer in a vertical direction (z-axis) and a new layer of resin is deposited again. Through this process, the structure 300 is manufactured one layer by one layer.

That is, the recoater blade refines the surface of the one layer of the resin layer which is deposited by curing the photocurable liquid resin 500 one layer by one layer. After the recoater blade refines the surface of the resin layer, the structure 300 is formed by repeating the process of: moving the build plate 400 by a thickness of one layer of the resin layer in the vertical direction, further depositing a new layer of resin layer, and refining the surface of the one layer of the resin layer which is newly deposited, by the recoater blade.

Referring to FIG. 3, the recoater blade may be located (longitudinal in the y-axis) at one end of the build plate 400 of the xy plane. Then, when refining one layer of the cured resin layer, the entire recoater blade moves in the x-axis direction and then returns to refine the resin layer.

A 3D printer having a fine hole processing function according to an embodiment of the present invention includes a second laser unit 200. The second laser unit 200 is disposed to be spaced apart from the first laser unit 100 by a predetermined distance. The second laser unit 200 forms a fine hole by irradiating a second beam 220 to the structure 300 where the photocurable liquid resin 500 is cured and deposited on the build plate 400.

More specifically, the second laser unit 200 is disposed to be spaced apart from the first laser unit 100 by a predetermined distance.

The second beam 220 generated by the second laser unit 200 is a laser beam having a laser drilling function. Specifically, the second beam 220 emitted from the second laser unit 200 is a UV solid laser beam. The second laser unit 200 may adjust variables such as wavelength, pulse, and laser power of the laser beam. Accordingly, the fine holes may be generated with the location, shape, diameter, and density of the fine holes being set according to the user's desired purpose.

The second beam 220 generated by the second laser unit 200 is irradiated to the structure 300 through the second scanner 210.

Here, the second scanner 210 may allow the laser transmitted from the second laser unit 200 to accurately reach a designated coordinate of the build plate 400. The second scanner 210 may include a galvanometer and an xy scanning mirror.

A method of operating an SLA 3D printer equipped with a laser drilling function according to an embodiment of the present invention is as follows. That is, a method of processing fine holes in a structure with a 3D printer having a fine hole processing function is as follows.

The position of the fine holes on the xy plane of the structure 300 to be output is set to be constantly processed up to a first point in the z-axis direction. When set in this way, a fine hole may be processed in the structure 300 to be output through the following steps.

In the first step, when a modeling file of the structure 300 to be output is input to the 3D printer, the first laser unit 100 irradiates the first beam 120 to the build plate 400. Accordingly, the photocurable liquid resin 500 contained in the water tank 600 is cured and deposited one layer by one layer to output a first structure 300 up to the first point in the z-axis direction.

In the second step, the second laser unit 200 irradiates the second beam 220 to the first structure 300 which is output up to the first point in the z-axis direction to form a first fine hole in the first structure 300.

The position of the fine hole on the xy plane of the structure 300 to be output may be set to be changed from the first point to the second point in the z-axis direction. When set in this way, a fine hole may be processed in the structure 300 to be output through the following steps.

In the third step, the first laser unit 100 irradiates the first beam 120 to the photocurable liquid resin 500 on the first structure 300 where the first fine hole is formed. Accordingly, the photocurable liquid resin 500 contained in the water tank 600 is cured and deposited one layer by one layer to output the second structure 300 up to the second point in the z-axis direction.

In the fourth step, the second laser unit 200 further irradiates the second beam 220 to the second structure 300 which is output up to the second point in the z-axis direction to form a second fine hole in the second structure 300. By using the fourth step, fine holes may be processed with a 3D printer having a fine hole processing function.

More specifically, the user inputs a 3D modeling file of the structure 300 to be generated (output) into software for a 3D printer. The user may designate a portion of the structure 300 which requires processing of fine holes. The fine holes may be partially or entirely designated as much as the user wants in the structure 300. Accordingly, the shape and diameter of the fine holes and the density of the fine holes in the designated area may be set.

When the modeling file of the structure 300 is input to the 3D printer, the first laser unit 100 irradiates the first beam 120 onto the build plate 400. Accordingly, the photocurable liquid resin 500 contained in the water tank 500 is cured and deposited one layer by one layer.

When the structure 300 is viewed from above, when the position of the fine holes on the xy plane (a plane consisting of the x-axis and y-axis) is set to be constantly processed over the entire z-axis direction, the first laser unit 100 irradiates the first beam 120 to output the entire structure 300, and then, the second laser unit 200 irradiates the second beam 220 to process (form) the fine holes in the structure 300.

Alternatively, there is a case where the position of the fine pores on the xy plane varies depending on the z-axis of the structure 300.

For example, there is a case where the position of the fine hole on the xy plane is changed at the middle point (1/2) of the z-axis of the structure 300, and the user may set such a case. Specifically, it is assumed that a first fine hole exists from the first point (0/2) to the middle point (1/2) of the z-axis of the structure 300, and a second fine hole having a condition different from the first fine hole exists from the middle point (1/2) to the last point (2/2) of the z-axis of the structure 300 will be described as follows.

First, the first laser unit 100 irradiates the first beam 120 onto the structure 300 to be output by the 3D printer from the first point (0/2) to the middle point (1/2) of the z-axis of the structure 300. Accordingly, the first laser unit 100 outputs the structure 300 by depositing the photocurable liquid resin 500 one layer by one layer.

In addition, the second laser unit 200 equipped with the laser drilling function irradiates the second beam 220 to generate the first fine hole in the z-axis direction according to the position, shape, diameter, and density on the xy plane which was input before printing.

In addition, the first laser unit 100 further irradiates the first beam 120 onto the structure 300 which was output to the middle point (1/2) of the z-axis of the structure 300. Accordingly, the photocurable liquid resin 500 is cured and deposited one layer by one layer to output the structure 300 from the middle point (1/2) to the last point (2/2) of the z-axis of the structure 300.

And, the second laser unit 200 irradiates the second beam 220 onto the output structure 300 to the last point (2/2). Accordingly, the second micropores are created in the z-axis direction to match the position, shape, diameter and density on the xy plane.

In this way, fine holes under various conditions may be formed differently for each portion of the structure 300 in the structure 300 to be output by a 3D printer.

The SLA type 3D printer including the second laser unit 200 mounted with the laser drilling function according to an embodiment of the present invention may elaborately manufacture a complex structure 300 to be output by a 3D printer. In addition, various types of micropores may be efficiently generated in the structure 300 without additional manpower input or processing.

The user can set the position, form, diameter, and density of the fine holes to form the desired fine holes by adjusting the laser drilling variables.

In addition, fine holes may be generated by selecting the entire or an area desired by the user of the output structure 300. In addition, fine holes may be generated by varying the position, shape, diameter, and density of fine holes for each area of the structure 300.

A 3D printer having a fine hole processing function according to an embodiment of the present invention may economically and quickly manufacture various structures 300 necessarily accompanied by waterproof, internal air circulation, and heat dissipation, such as ventilation of an undersea tunnel or a component material for electronic packaging.

Features, structures, effects, etc. described in embodiments are included in at least one embodiment of this invention and are not necessarily limited to one embodiment. Furthermore, the features, structures, effects, and the like illustrated in each embodiment may be implemented in combination or modification with respect to other embodiments by a person skilled in the art to which the embodiments belong. Therefore, it should be interpreted that the contents related to these combinations and modifications are included in the scope of the present invention.

In addition, although the embodiment has been mainly described above, this is merely an example and this invention is not limited, and it will be appreciated by a person skilled in the art that various modifications and applications not illustrated are possible within the scope not departing from the present invention. That is, each component specifically shown in the embodiment may be modified and implemented. And differences related to these modifications and applications should be interpreted as falling within the scope of the present invention as defined in the appended claims.

### DESCRIPTION OF REFERENCE NUMERALS

100: The first laser unit.

110: The first scanner.

120: First beam.

200: The 2nd laser unit.

210: The 2nd scanner.

220: Second beam.

300: Structure

400: A build plate.

500: Photo-curable liquid resin

600: A water tank.

1. A 3D printer with a fine hole processing function, comprising:
a build plate disposed in a photocurable liquid resin contained in a water tank;
a first laser unit disposed on the water tank and the photocurable liquid resin, for irradiating a first beam to the photocurable liquid resin on the build plate to cure and laminate the photocurable liquid resin one layer by one layer on the build plate thereby forming a structure, and
a second laser unit disposed to be spaced apart from the first laser unit by a predetermined distance, for irradiating a second beam to the structure where the photocurable liquid resin is cured and deposited on the build plate thereby forming a fine hole,
wherein the first beam is an ultraviolet laser beam for curing, and the second beam is an ultraviolet solid laser beam having a laser drilling function.

2. The 3D printer with a fine hole processing function of claim 1, wherein
the first beam generated by the first laser unit is irradiated to the photocurable liquid resin through a first scanner, and
the second beam generated by the second laser unit is irradiated to the structure where the photocurable liquid resin is cured and deposited, through a second scanner.

3. The 3D printer with a fine hole processing function of claim 1, further comprising:
a recoater blade for refining the surface of the one layer of the resin layer where the photocurable liquid resin is cured and deposited one layer by one layer.

4. The 3D printer with a fine hole processing function of claim 3, wherein
after the recoater blade refines the surface of the one layer of the resin layer,
a structure is formed by repeating the process of:
moving the build plate by a thickness of one layer in a vertical direction,
further depositing a new layer of resin layer, and
refining by the recoater blade the surface of the one layer of the resin layer which is newly deposited.

5. A method of processing fine holes with a 3D printer having a fine hole processing function,
where a position of a fine hole on a xy plane of a structure 300 to be output is set to be constantly processed up to a first point in a z-axis direction,
comprising:
a first step, when a modeling file of the structure to be output is input to the 3D printer, where the first laser unit irradiates the first beam to the build plate, and accordingly, the photocurable liquid resin contained in the water tank is cured and deposited one layer by one layer to output a first structure up to the first point in the z-axis direction, and
a second step where a second laser unit irradiates a second beam to the first structure which is output up to the first point in the z-axis direction to form a first fine hole in the first structure,
wherein the first beam is an ultraviolet laser beam for curing, and the second beam is an ultraviolet solid laser beam having a laser drilling function.

6. The method of processing fine holes with a 3D printer having a fine hole processing function of claim 5,
when a position of a fine hole on the xy plane of the structure to be output is changed from the first point to a second point in the z-axis direction,
further comprising:
a third step where the first laser unit irradiates the first beam to the photocurable liquid resin on the first structure, and accordingly, the photocurable liquid resin contained in the water tank is cured and deposited one layer by one layer to output a second structure up to the second point in the z-axis direction, and
a fourth step where the second laser unit further irradiates a second beam to the second structure which is output up to the second point in the z-axis direction to form a second fine hole in the second structure.

7. The method of processing fine holes with a 3D printer having a fine hole processing function of claim 5, wherein
a recoater blade refines a surface of the one layer of the resin layer which is deposited by curing the photocurable liquid resin one layer by one layer.

8. The method of processing fine holes with a 3D printer having a fine hole processing function of claim 7, wherein
after the recoater blade refines the surface of the one layer of the resin layer,
a structure to be output is formed by repeating the process of:
moving the build plate by a thickness of one layer in a vertical direction,
further depositing a new layer of resin layer, and
refining by the recoater blade the surface of the one layer of the resin layer which is newly deposited.
